(19) United States
(12) Patent Application Publication
(10) Pub. No.: US 2013/0279877 A1
(43) Pub. Date: Oct. 24, 2013

(54) System and Method Of Video Decoder Resource Sharing

(71) Applicant: Adrian BOAK, Woodlawn (CA)

(72) Inventor: Adrian BOAK, Woodlawn (CA)

(73) Assignee: QNX SOFTWARE SYSTEMS LIMITED, Kanata (CA)

(21) Appl. No.: 13/451,140

(22) Filed: Apr. 19, 2012

(51) Int. Cl. H04N 5/917; H04N 5/775

(52) U.S. Cl. CPC H04N 5/917; H04N 5/775
USPC 386/231; 386/354; 386/349; 386/241

(57) ABSTRACT

A shared decoder resource is assigned to an input buffer providing an input data stream to generate a decoded output data stream. An event is detected that switches a preferred allocation of the video decoding resource relative to the application. The application using the video decoder is instructed to release the video decoder resource. The video decoding resource is then re-allocated to another input buffer to provide an input data stream of an other application to the video decoder to generate the output data stream. The input buffer of the input data streams associated with the application prior to receiving the event is maintained in a suspended state while the respective application is still active but is not associated with the video decoder.

### TECHNICAL FIELD

The present disclosure relates to graphics and multimedia on computing devices and in particular to video decoding resource sharing in a mobile device.

### BACKGROUND

Video compression systems that perform decoding and/or encoding often require a large amount of computing resources. These resources can include the component that performs the encoding/decoding operation (central processing unit (CPU), graphics processing unit (GPU), custom hardware, etc.) along with a memory interface capable of sustaining the necessary throughput for displaying the decompressed or decoded video. Typically higher video resolution requires more computing resources but these resources are usually limited. For example, both the memory and the computing component operate at finite clock speeds. Custom hardware configurations are often used to efficiently implement the encoding/decoding operation but these usually have limited concurrent operation capability when compared to a CPU.

A computing system can be required to decode multiple video streams concurrently. For example, a single webpage can have multiple embedded video advertisements. A computing system that enables true multitasking can have multiple programs with video decoding requirements operating concurrently. One way that a personal computer handles this is by running all the applications concurrently and having the video decode controller software drop or skip video when it runs out of resources. Another solution when the system has separated dedicated hardware decoding resources allows the first application that requires video decoding to have the hardware resource and then the subsequent video applications use software decoders on the main CPU. These solutions typically have side effects like dropped frames. Embedded computing platforms including mobile devices, such as mobile phones and tablet computers, may not have enough resources to handle these concurrent operation methods without significant playback degradation which is often unacceptable. Embedded computing platforms can have multitasking capability similar to a personal computer but their user interface may be more restrictive in that it can only display a limited number of applications concurrently. This restriction is often necessary because the displays are much smaller, however a multitasking environment may enable multiple concurrent playback streams to be initiated, although not concurrently viewable by the user, taxing the decoding resource available in the embedded device.

Accordingly, systems and methods that enable sharing of a video decoding resource remains highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of a video application using a video decoding resource;

FIG. 2 shows a representation of multiple video applications sharing a video decoding resource;

FIG. 3 shows a representation of video application switching on a mobile device;

FIG. 4 shows a schematic representation of a shared video decoding resource;

FIG. 5 shows a method of sharing a video decoding resource;

FIG. 6 shows an alternative method of sharing a video decoding resource; and

FIG. 7 shows mobile device providing a shared video decoding resource.

It will be noted that throughout the appended drawings, like features are identified by like reference numerals.

### DETAILED DESCRIPTION

In accordance with an aspect of the present disclosure there is provided a method of video decoding resource sharing, the method comprising: associating a video decoder with a first input buffer for a first encoded input data stream from a first application, the video decoder processing the first encoded input data stream to generate a decoded output data stream for display; detecting an event associated with a second application that identifies a change in the video decoder allocation between the first encoded input data stream from the first application to a second encoded input data stream from the second application is required; instructing the first application to release the video decoder; and associating the video decoder with a second input buffer for the second encoded input data stream from the second application to provide the decoded output data stream for display, when the first application releases the video decoder, wherein the first input buffer is maintained in a suspended state while the second encoded input data stream is processed by the video decoder.

In accordance with another aspect of the present disclosure there is provided a mobile device comprising: a video decoder for decoding an encoded input data stream to provide a decoded output data stream for display on the mobile device; a processor for executing applications associated with a respective encoded input data stream for display on the mobile device; a memory for storing input buffers for providing data from an encoded input data stream to the video decoder when required by a respective associated application; and a system controller for: receiving an event identifying a change in the video decoder allocation between applications is required; instructing the application assigned to the video decoder prior to receiving the event to release the video decoder, wherein the associated input buffer is placed in a suspended state until the video decoder is re-associated with the respective application; and associating an input buffer associated with the application of the event to the video decoder to decode the respective input data stream to the decoded output data stream.

In accordance with yet another aspect of the present disclosure there is provided a computer readable memory containing instruction which when executed by a processor perform a method of video decoding resource sharing, the method comprising: associating a video decoder with a first input buffer for a first encoded input data stream from a first application, the video decoder processing the first encoded input data stream to generate a decoded output data stream for display; detecting an event associated with a second application that identifies a change in the video decoder allocation between the first encoded input data stream from the first application to a second encoded input data stream from the second application is required; instructing the first application to release the video decoder; and associating the video decoder with a second input buffer for the second encoded input data stream from the second application to provide the decoded output data stream for display, when the first application releases the video decoder wherein the first input buffer is maintained in a suspended state while the second encoded input data stream is processed by the video decoder.

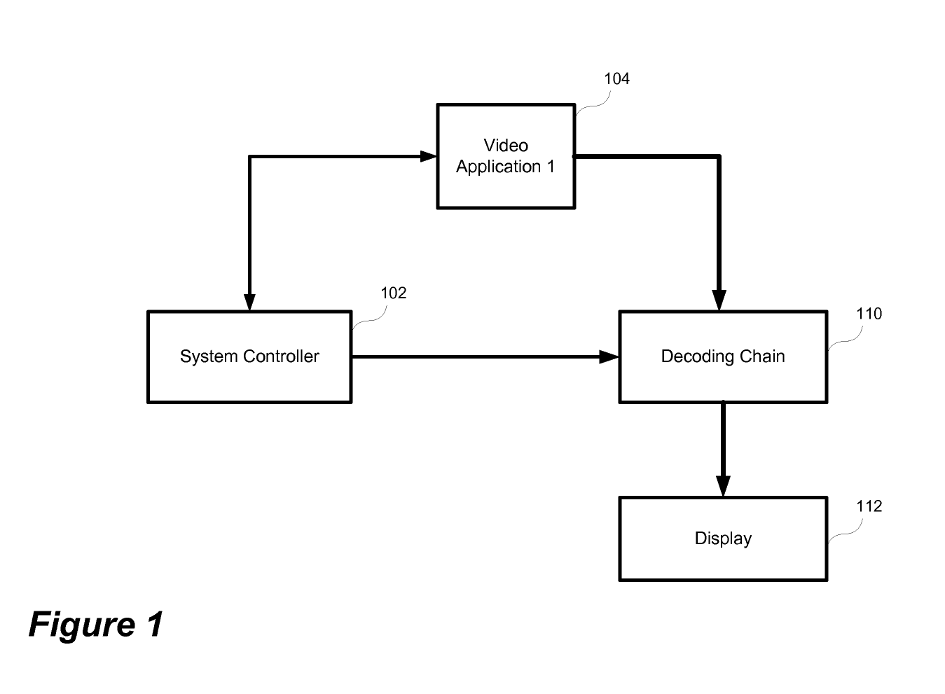

Embodiments are described below, by way of example only, with reference to FIGS. 1-7. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

When multiple applications on multitasking operating system/devices are simultaneously using video decoding resources, the disclosure provides the ability to control and limit the access to shared video decoding resources to an application that is currently displayed. Shared video decoding resources may include software or hardware video decoders, video output buffers, internal video decoder state buffers and video layers in a display controller. When an application that requires a video decoding resource is initiated, or selected by a transition from a background to a foreground viewing position within a user interface, the video decoding resource shared between applications is reassigned to the foreground application. Applications that are not currently assigned to use the video decoder resource, but are still active in the background, and may at some future time require the video decoding resource again, can have associated non-shared input buffers resources required for processing the video data be suspended and maintained until they are required again. A system controller determines which application requires the video decoding resource based upon an event, such as a position of the application within the user interface, and can then assign appropriate resources to the application while maintaining established input buffer resources for applications that are active yet do not require access to the video decoding resource based on the change resulting from the event, such as no longer being visible in the user interface. The sharing of video decoding resource while maintaining individual non-shared input buffers, each associated with a particular application enables the video decoding resource to be more efficiently used, while allowing applications to quickly resume playback of video once required.

FIG. 1 shows a representation of a video application using a video decoding resource. A first video application 104 presents, on a display of the device, a video data stream that has been encoded to conserve bandwidth and storage space. The data may be encoded in a standard format such as H.263, H.264, MPEG-2, or other similar formats, and provided in a data file or as streaming data through a network interface of the device. The encoded format can be decoded in hardware or software. When the first video application 104 requires video playback, the system controller 102 can assign the decoding chain 110 to the first video application 104. The decoding chain 110 may include a reader for reading data from a file or network interface, buffers for storing the video data of sufficient size to account for video resolution and codec quality setting, a parser for determining frame information and extracting additional data from the stream for processing such as audio or metadata, and a decoder to decode the input data stream to a format suitable for display. The decoding chain 110 provides the decoded video data to an output buffer which can then be processed, for example by performing layering and composition with other graphics, for presentation on the display 112.

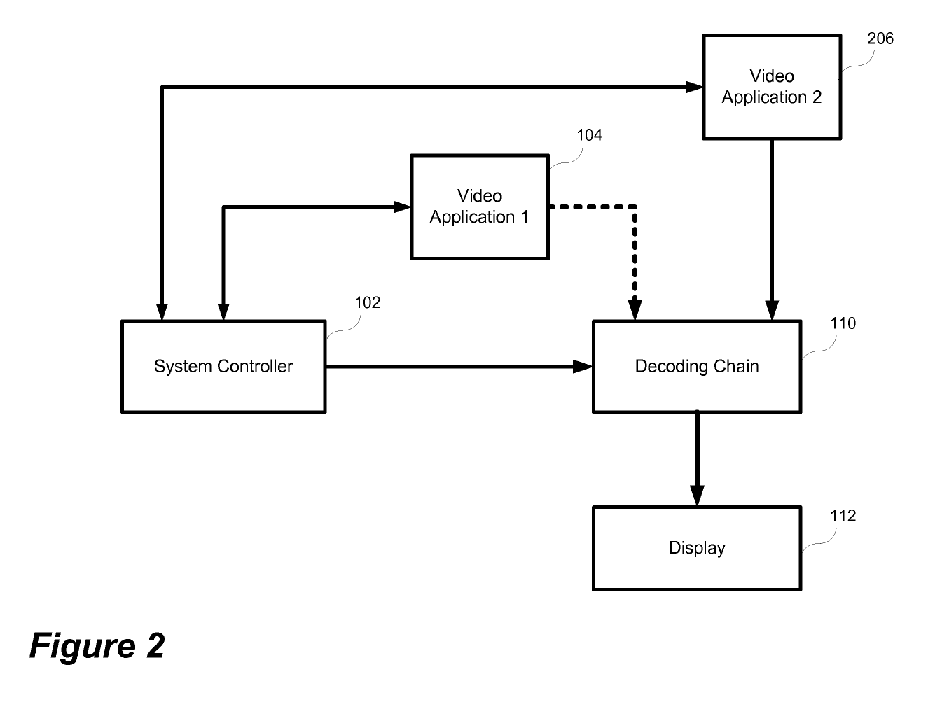

When multiple applications are active on a device as shown in FIG. 2, each having a requirement to decode and present video, only one application may be serviced at a time by the video decoding resources. In this example the first video application 104 and second video application 206 are active on the device, however due to limited video decoding resources, the video decoder of the decoding chain 110 may only be capable of decoding a single, or limited number of input data streams at a given time. Therefore if both video streams are concurrently viewed, other video decoding resources may be utilized for the additional streams such as by software decoding by the CPU. In computing devices such as mobile devices where screen size is limited, the need to process multiple video sources concurrently is limited due to display size limitations and user interface interaction limitations. However, the applications may both be in an active state, but they may not both be visible at the same time as the user must switch between them for the application to be visible. For example the second video application 206 may be in the foreground while the first video application 104 is in the background and not visible, but is still in an active or suspended state. The foreground position would identify that the video decoding resource is required to display content from the second video application 206; however an event may occur to change the preference and switch the first video application 104 to the foreground position over the second video application 206. The first video application 104 would then acquire the decoding chain 110 to display the video content. In limited resource implementations the decoding chain 110, including the input and output buffers may be re-initiated using a bookmark or index into the video file or stream being decoded to re-initiate playback at, within the input video data file or input video data stream each time there is a switch between applications to a viewable position. However, re-initiating the full decoding chain 110 may result in a delay in playback and responsiveness in the user interface of the device while initiating the decoding chain 110 on each transition between applications.

To mitigate the delay, the system controller 102 can share the resources in the decoding chain 110, and allocate resources within the chain as a shared resource such as a video decoder, and a non-shared resource, such as input buffers, to each application. Defining the input buffers as non-shared resources, in the input to the video decoder, enables faster transitions between applications requiring the video decoding resources. This may be achieved by the system controller 102 being aware of which application is visible in the user interface and assigning the video decoder and an associated input buffer to the application without having to re-initiate or populate input buffers for each transition between applications. Applications that require the video decoding resource can coordinate with the system controller 102 to determine which application gets access to the limited video resources, including the video decoder, and input buffers associated with the application in the decoding chain 110. The input buffer for each application are maintained when the video stream from the particular application is not being processed but the associated application is still active, whereas the video decoder is shared between applications with the system controller granting and removing access based upon an event identifying a transition between applications. For example, a multitasking computing system that displays a single application at a time may allow access to the shared video resources only to the application that is currently being displayed on the display screen of the device. By segmenting the decoding chain 110 into the non-shared input buffer resources and the shared video decoder resource, input buffers can be maintained on a per application basis such that when the system controller 102 can identify that an application may not have priority to the video decoding resource, such as not being visible on the display of the device, but may eventually require it, and can quickly re-assign of the shared video decoder resources.

Each application that requires video decoding resources may communicate with the system controller 102 in order to access the decoding chain 110. When instructed, each video application must free the video decoder resources and stop utilizing them until the system controller once again grants access. The non-shared input buffer resources can be maintained for active applications; however the output buffer of the video decoder resources can be reassigned at the same time the system controller grants access. The output buffer may include the state video buffers utilized by the video decoder. Although the output video buffer may be part of the decoding chain assignment, the output video buffer may be re-initialized in memory with each event identifying an application transition to assign the shared video decoder resources and may not maintain or share data between applications. Keeping the input buffer resources active can allow a faster restart of decoding once the application acquires access to the shared video resources again as the input stream buffers do not need to be re-loaded from the file or stream. The input buffer portion allocated to each application provides enough video stream data to allow for initial memory or network access request to retrieve more video data when restoring the video and reduce re-start delay.

In an encoded video sequence the size of the data defining a video frame is reduced by encoding the video data. In encoding video different types of frames are created to optimize bandwidth, however when restarting playback of a video stream, the next available frame in the input buffer may not have sufficient information to produce an image. For example, an Intra-frame (I-frame), so-called because they can be decoded independently of any other frames can produce a full image, where as a Predicted-frame (P-frame), which may also be called forward-predicted frames, exists to improve compression by exploiting the temporal (over time) redundancy in a video but can not produce an image independently. P-frames store only the difference in an image from the frame (either an I-frame or P-frame) immediately preceding it (this reference frame is also called the anchor frame). A bidirectional-frame (B-frame) is similar to P-frames, except they can make predictions using both the previous and future frames and like P-frames can not produce an image independently. The frames are provided in a group of pictures (GOP) defining a frame structure such as IBBPBBP . . . . The I-frame is used to predict the first P-frame and these two frames are also used to predict the first and the second B-frame. The second P-frame is predicted using the first P-frame and they join to predict the third and fourth B-frames. The size of the GOP defines the number of I-frames to non-I-frames and will have an impact on the buffer size.

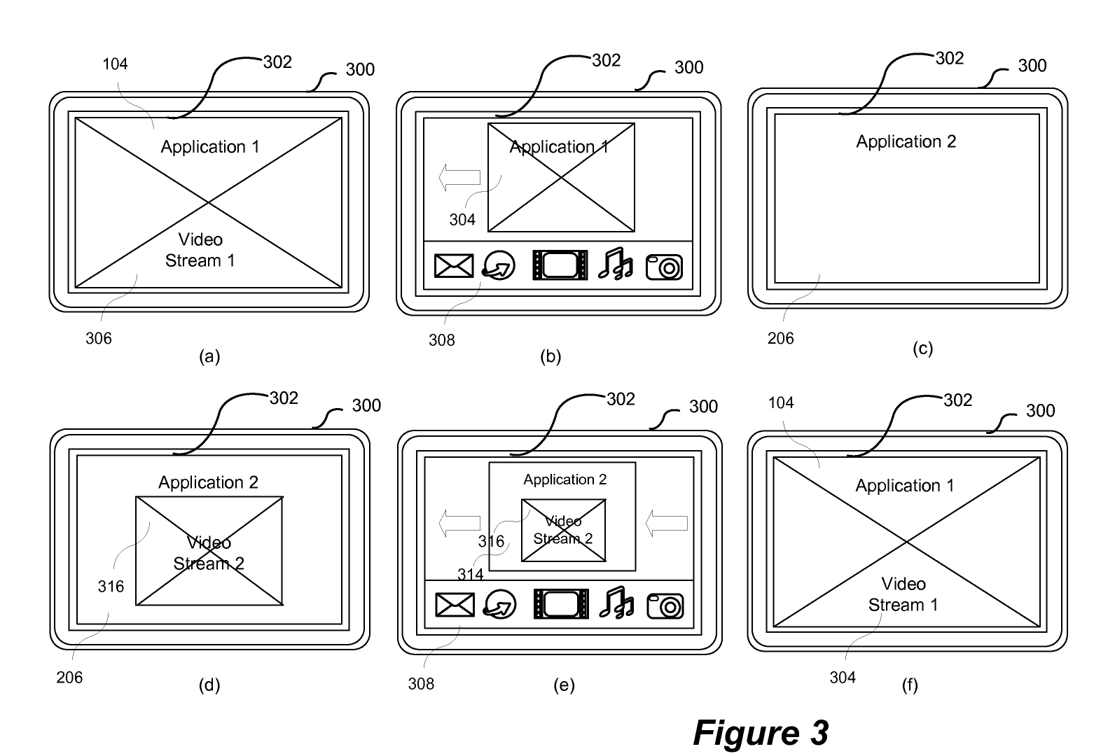

FIG. 3 shows a representation of video application switching on a portable electronic device. As shown in FIG. 3(a), the mobile device 300 has a display 302 that displays a first video stream 306. In this example the video stream is presented in full screen mode, therefore the first video application 104 is a media player providing a full screen display. The video decoding resources are allocated to the decoding of the stream for the first video application 104. The first video application 104 can then be moved to a background or non-visible state, as shown in FIG. 3(b) but is still active while other actions within the user interface occur. The processing of the first video stream 306 may continue by the video decoder resources, with audio playback and progress through the stream continuing as no request has been made by the second video application 206 for the video decoding resource. When a second video application 206 is executed, for example a web browser from a task bar 308, the first video application 104 is moved to the background and is not visible as shown in FIG. 3(c). An event that switches the state of the currently decoding application may occur, for example, as shown in FIG. 3(d), when the user initiates a process of selecting a second video stream 316 in the second video application 206. In this example the video stream player is embedded within the second video application 206. The second video application 206 requests access from the system controller 102 to the video decoder resources that are currently assigned to the first video application 104. The system controller 102 notifies the first video application 104 to release the video decoder resources halting playback of the first video stream 306. The first video application 104, may release the video decoder resources but suspend and maintain non-shared input buffer resources in the decoding chain 110 that service the video decoder resources. The buffer resources such as an input buffer, a reader, and a parser including a parser buffer, can remain active and allocated to the application in memory but not process data when not actively associated with the video decoding resource. The non-shared input buffer resources are maintained as long as the first video application 104 is in an active state, though not necessarily in the foreground or visible. A second input buffer is then assigned to the second video stream 316 for the second video application 206 and processing is commenced by the video decoder resources.

As shown in FIG. 3(e) when a subsequent event such as a swipe to switch the second video application 206 to the background is performed, the decoding of the second video stream 316 can continue until the first video application 104 is brought to the foreground on the display 302 of the device 300. The system controller 102 determines that an event such as the transition has occurred and notifies the second video application 206, or associated media player, to release the video decoder resources and re-allocates the video decoder resources to the first application 104. As shown in FIG. 3(f) the first video application 104 can resume playback with the data in the input buffer being processed from the previous suspended state. The input buffer may be of sufficient memory depth to ensure that an I-frame is present in the input buffer to ensure quick resumption of the video decoding process. By maintaining the input buffers, decoding of the input data stream can quickly resume by the video decoders resources using the data maintained in the input buffer while providing sufficient time to re-acquire the data stream or re-access the associated data file in memory.

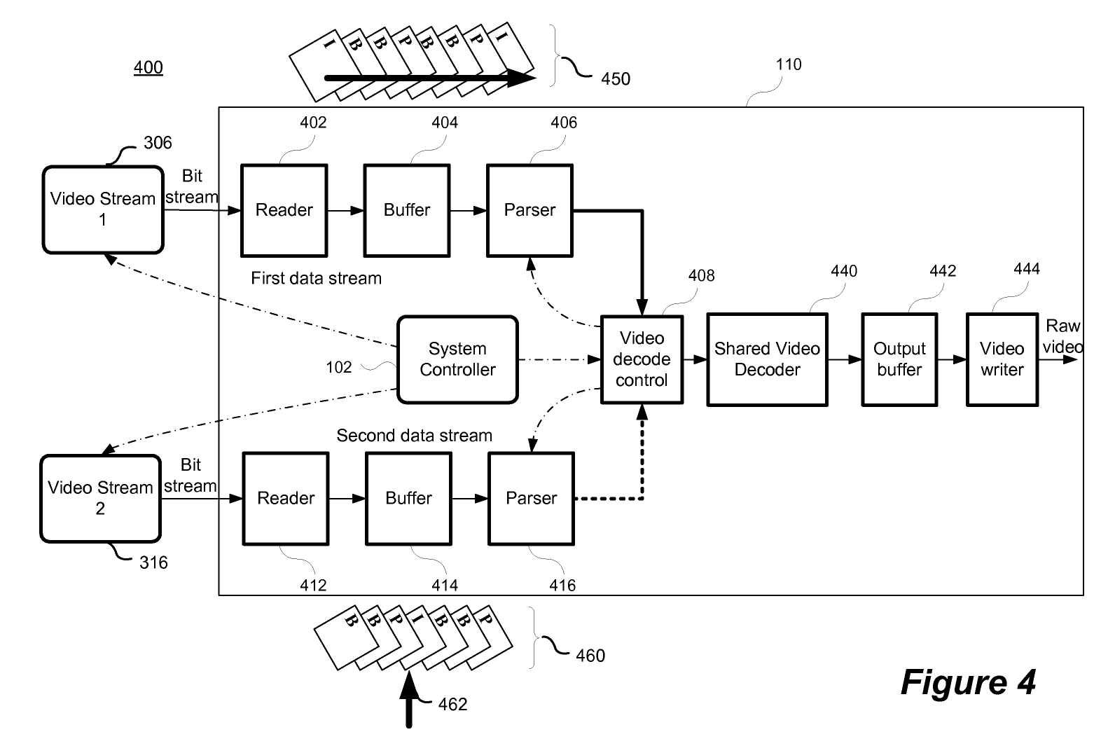

FIG. 4 shows a schematic representation of video decoding chain 400. The first video stream 306 provides input bit stream data to reader 402, or directs reader 402 to retrieve the encoded bit stream of the video. The input bit stream data is provided to input buffer 404, contained in one or more memory devices, and is parsed by parser 406 to extract, from the video stream, video frames 450 and non-video data, such as metadata and audio, to be processed independently. The video frames 450 contained in the buffer 404 may be compressed video frames. The video decode control 408, controls access to the shared video decoder 440. There may also be a buffer between the parser and the shared video decoder 440 that may be associated with the non-shared resource. The video decoder 440, that can be a dedicated hardware resource, can then decode the video stream frames 450 and provide them to output buffer 442 implemented in one or more memory of the devices. The video output buffer 442, containing the decoded video frames, provides the frames to a video writer 444, which may then be further processed before being displayed such as by performing layering and composition before providing the raw video to a display interface. The system controller 102 controls allocation of the shared video decoder 440 and the shared video decoding resources such as output buffer 442 and video writer 444 to applications. The system controller 102 notifies the respective application when to release the video decoder 440 for re-allocation to another application. The non-shared resources associated with the second video application 206 providing the second video stream 316 has the same configuration as the first data stream input with a reader 412, input buffer 414, parser 416 etc., however the non-shared resources may be configured differently based upon the encoding characteristics of the video stream. For example, resolution, bit rate, and coding parameters of the video data stream may require the input buffer resources to be configured differently. In this example, the second video application 206 is in a paused state due to the video decoding resource 440 being allocated to process the first video application 104. The input buffer 414 is in a suspended state until an event occurs that identifies to the system controller 102 that the second application 206 requires the shared video decoder 440 and associated resources. When an event occurs to identify that the second video application 206 is in a primary viewing position, such as being in the foreground in the user interface, and playback of an associated video stream is required, the system controller 102 instructs the first video application 104 to release the video decoder 440. The second application 206 is then re-allocated to the video decoder 440 and the video decode control 408 instructs the associated parser 416 to process the stored frames 460 stored in the buffer 414 to identify an I-frame 462 to enable a smooth resumption of playback. The parser 416 may require the reader 412 to load more stored frames 460 into the buffer 414 to find an I-frame 462. The parser 416 may also queue the additional data such as audio data and metadata to correspond to the identified key frame to ensure synchronization during playback. When the video decoder 440 is re-allocated, processing resources that are decoder dependent, such as the output buffer 442, may be released and re-initialized whenever there is a re-assignment of the shared video decoder 440. The output buffer 442 may vary in size based upon the input video stream processing characteristics and does not need to be maintained as a non-shared resources but is dependent on the operation of the decoding chain 110 for the particular video data stream.

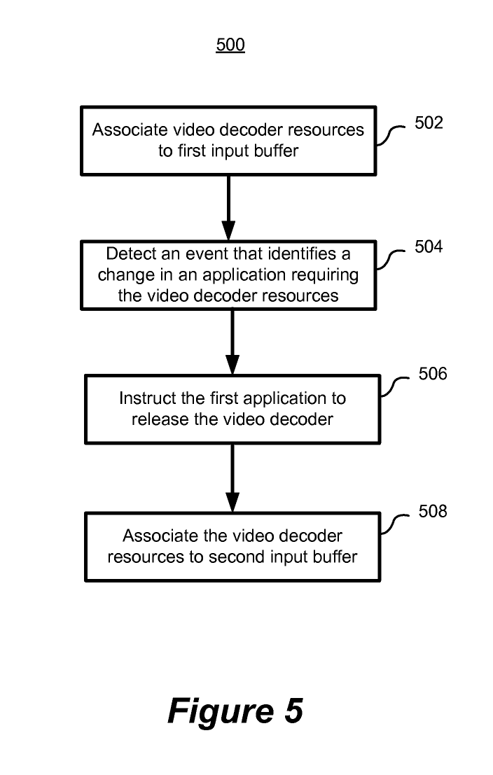

FIG. 5 shows a method 500 of decoder resource sharing. A video decoder 440 is associated to a first input buffer (502) for providing a first input data stream of a first application such as when video playback is commenced. The video decoder 440 processes the first input data stream to generate an output data stream that is provided for display. An event that identifies that a change in the decoder chain between the first input data stream from the first video application 104 to a second data input stream from a second video application 206 is required (504). The event may be a change in an application focus where the second video application 206 is moved to the foreground and the first video application 104 is moved to the background, or where the first video application 104 is no longer visible, but is still active and accessible within the user interface. The application currently using the video decoder 440 is instructed to release the video decoder 440 by the system controller 102. The video decoder 440, and the associated shared resources are then associated to a second input buffer (508) to provide the second input data stream of the second video application 206, such as a video data stream, to generate the output data stream for display on the device. The first input buffer is maintained providing the first input data stream in a suspended state while the first video application 104 is still in an active state. The first input data stream associated with the first input buffer is paused while the second input data stream is being decoded by the shared video decoder 440. The first input data stream can be quickly resumed for playback when a subsequent event occurs to change the application focus and re-initiate playback, enabling sufficient time for data to be retrieved from the input data stream source and reduce playback restart delay. Output buffer associated with the video decoder may be considered a shared resource however they may be released and re-initiated whenever an event occurs requires the video decoder 440 to process an input video data stream.

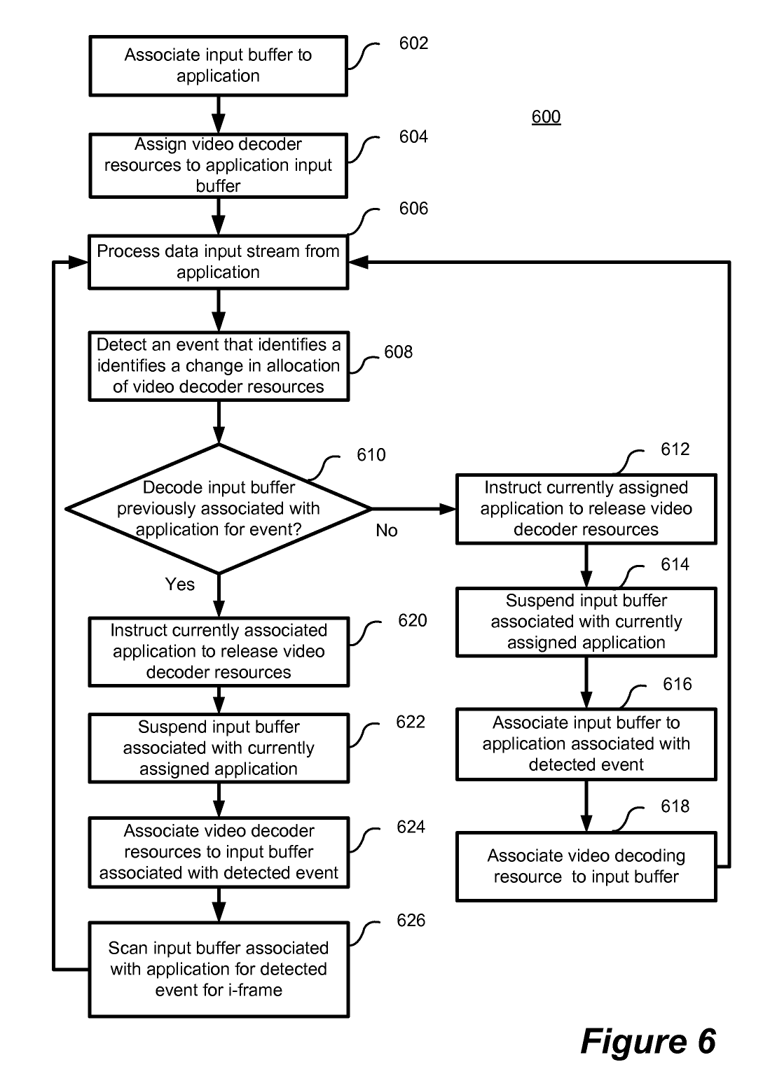

FIG. 6 shows an alternative method 600 of video decoder resource sharing. The method commences when an application requires the decoding chain that has not been assigned to an application. When an application requests the decoding chain, the video decoding resources of the decoding chain is associated (602) with the application by the system controller 102. The video decoder 440 is assigned to a non-shared input buffer that is associated with the application (604) and commences processing the data provided by the application, such as encoded video in an input data stream (606). The shared video decoder 440 then processes the content of the input buffer to provide output data that is then displayed in the associated application on a display of a device. While the input data stream is being processed an event may be detected that identifies requests a change to the allocation of the video decoding chain, and in particular the video decoder (608) is required. For example the movement of an application window to the foreground or initiating playback of a video. The system controller 102 determines that an application that is visible on the display, or most visible, requires the video decoder 440 to present the output video stream and takes precedence over the application currently using the video decoder 440. If the application associated with the event does not have an input buffer already associated with it (NO at 610), the system controller 102 can instruct the currently assigned application to release the shared video decoder resource (612), and the associated resources such as the output buffer. The non-shared input buffer of the application currently allocated to the video decoder 440 is suspended (614) via the decode control block. In suspending the input buffer, the data in the buffer is maintained and not deleted while the application is still active, although not necessarily visible on the display. A new input buffer is associated with the application requesting the video decoder 440 (616) and is associated with the new input buffer (618). The video decoder 440 can then process the input data stream provided by the input buffer (606) for display. If the video decoder 440 has been previously allocated to the application associated with the user event, (YES at 610) than an input buffer already exists for the application. The system controller 102 instructs the application that is currently utilizing the video decoder 440 to release the video decoder 440 (620) and associated resources such as the output buffer, and suspends the associated input buffer (622). The input buffer associated with the application of the user event is then assigned to the video decoder 440 (624). The input buffer is scanned by the parser for an intra-frame (626) to enable quick commencement of playback of the input data stream. The parser may scan for an I-frame before or after the point where decoding previously stopped which will then be provided to the shared video decoder. Alternatively the parser may scan for the previous I-frame, decode and not display the decoded frames until the video decoder is at the frame where the process was previously stopped to allow the system to start again exactly where it stopped as, for example, defined by a time index. The shared video decoder 440 can then decode the input data stream from the parser (606) and provide the decoded content such as video to an output buffer for further processing and/or display.

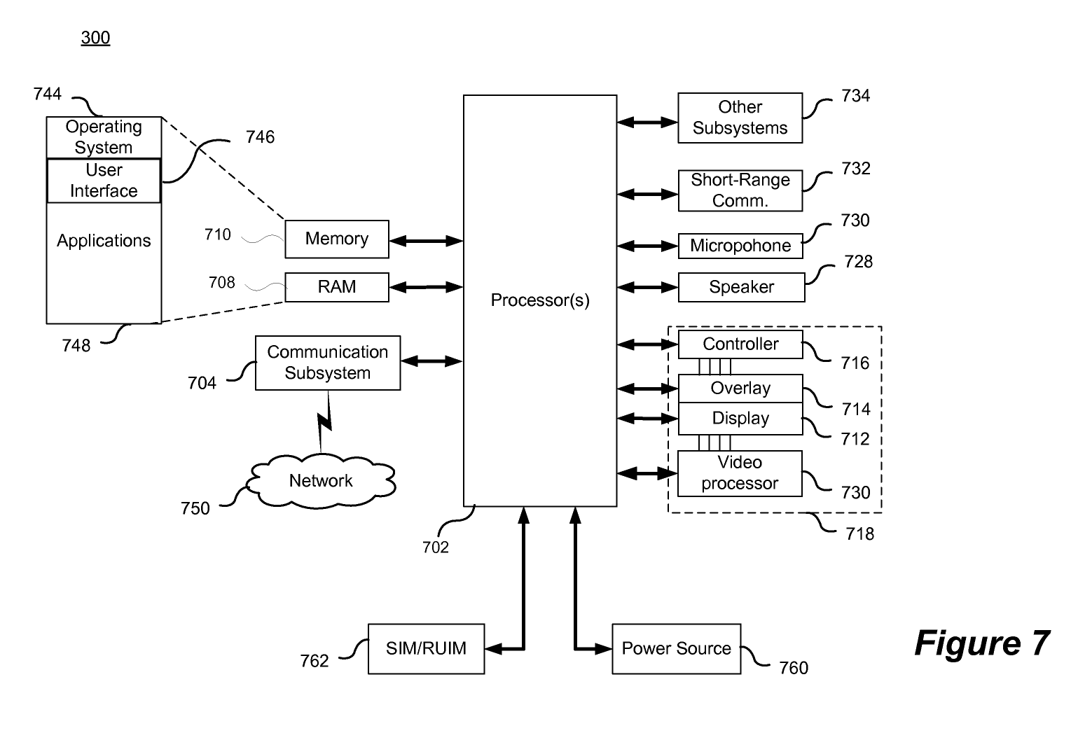

FIG. 7 is a schematic depiction of an example mobile device for providing video decoder resource allocation. As shown by way of example in FIG. 7, the mobile device 300, includes a processor (or microprocessor) 702 for executing one or more applications, memory in the form of flash memory 710 and RAM 708 (or any equivalent memory devices) for storing an operating system 744, the one or more applications 748, and a user interface 746 with which the user interacts with the device 300. The operating system 744 and the applications 748 that are executed by the microprocessor 702 are typically stored in a persistent store such as the flash memory 710, which may alternatively be a read-only memory (ROM) or similar storage element (not shown). Those skilled in the art will appreciate those portions of the operating system 744 and the applications 748, such as specific device applications, or parts thereof, may be temporarily loaded into a volatile store such as the RAM 708. The system controller may be implemented in the operating system 744 or as part of system drivers used by the operating system. The system controller functions are configurable based upon the associated hardware configuration defining the processing capability of the device and the number of hardware and software decoding processes available. Other software components can also be included, as is well known to those skilled in the art.

In an integrated mobile device having a touch screen interface a display subsystem 718, has a display 712 with an overlay 714 coupled to a controller 716 to enable a touch-sensitive user interface interaction. A video processor 730 provides graphics processing unit (GPU) for graphics rendering and shared video decoding functions for displaying the user interface on the display 712. Function of the video processor 730 may be provided by, or in conjunction with, the processor 702. The function provided by the video processor 730 may be limited to a number of hardware graphics rendering cores and decoding processors.

As shown by way of example in FIG. 7, the mobile device 300 may include communication subsystem 704 comprising a radiofrequency (RF) transceiver comprising a receiver and associated receiver antenna and transmitter and associated transmitter antenna. The mobile device 300 may be in a portable form factor such as a smart phone, tablet, net book, laptop, portable computing device or an integrated mobile computer device that may access different networks wirelessly. The RF transceiver for communication with a wireless network 750 using a wireless communication protocols such as, for example but not limited to, GSM, UMTS, LTE, HSPDA, CDMA, W-CDMA, Wi-MAX, Wi-Fi etc. A subscriber identify module (SIM) card 762 may be provided depending on the access technology supported by the device. Optionally, where the device is a voice-enabled communications device such as, for example, a tablet, smart phone or cell phone, the device would further include a microphone 730 and a speaker 728. Short-range communications 732 is provided through wireless technologies such as Bluetooth™ or wired Universal Serial Bus™ connections to other peripheries or computing devices or by other device sub-systems 734 which may enable access tethering using communications functions of another mobile device. In a tethering configuration the mobile device may provide the network information associated with the tethered or master device to be used to access the network. The mobile device 300 may have a power source 760 such as a battery or be connectable to an external power supply.

Although certain methods, apparatus, computer readable memory, and articles of manufacture have been described herein, the scope of coverage of this disclosure is not limited thereto. To the contrary, this patent covers all methods, apparatus, computer readable memory, and articles of manufacture fairly falling within the scope of the appended claims either literally or under the doctrine of equivalents.

Although the following discloses example methods, system and apparatus including, among other components, software executed on hardware, it should be noted that such methods, system and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods, system and apparatus.

1. A method of video decoding resource sharing, the method comprising:
associating a video decoder with a first input buffer for a first encoded input data stream from a first application, the video decoder processing the first encoded input data stream to generate a decoded output data stream for display;
detecting an event associated with a second application that identifies a change in the video decoder allocation between the first encoded input data stream from the first application to a second encoded input data stream from the second application is required;
instructing the first application to release the video decoder; and associating the video decoder with a second input buffer for the second encoded input data stream from the second application to provide the decoded output data stream for display, when the first application releases the video decoder, wherein the first input buffer is maintained in a suspended state while the second encoded input data stream is processed by the video decoder.

2. The method of claim 1, wherein the second encoded input data stream of the second application is displayed in a foreground position in a user interface on the display, the first application is active in a background position but not visible in the user interface on the display.

3. The method of claim 1, wherein the event is derived from a user action in the user interface to initiate or resume playback of the second encoded input data stream in the second application.

4. The method of claim 3, wherein the user action is derived by moving a display window of the second application to a foreground position on a display.

5. The method of claim 1, further comprising:
detecting a second event that identifies that returning the video decoder to the first encoded input data stream maintained in the first input buffer is required;
instructing the second application to release the video decoder; and
associating the video decoder with the first input buffer to provide the first encoded input data stream to the video decoder to resume processing of the first encoded input data stream by the video decoder, wherein the second input buffer is maintained in a suspended state while the first encoded input data stream is processed by the video decoder.

6. The method of claim 5 wherein the first input buffer is parsed to determine the first occurrence of an intra-frame to resume processing of the first input data stream by the video decoder.

7. The method of claim 5 wherein the first input buffer is parsed to determine the first occurrence of an intra-frame and then determining intermediate frames associated with a time index within the first encoded input data stream, the time index identifying where the processing of the first input buffer was previously suspended.

8. The method of claim 5 wherein the second event is derived from a user action in the user interface to resume playback of the first encoded input data stream in the first application.

9. The method of claim 8 wherein the user action is derived by moving a display window of the first application to a foreground position on a display.

10. The method of claim 1 wherein the decoded output data stream from the video decoder is provided to an output data buffer for display, wherein the output data buffer is released from memory when the event is detected and re-initialized when the video decoder is assigned to the second encoded input data stream.

11. The method of claim 1 wherein suspending first input buffer is preserved in memory while in the suspended state.

12. A mobile device comprising:
a video decoder for decoding an encoded input data stream to provide a decoded output data stream for display on the mobile device;
a processor for executing applications associated with a respective encoded input data stream for display on the mobile device;
a memory for storing input buffers for providing data from an encoded input data stream to the video decoder when required by a respective associated application; and
a system controller for:
receiving an event identifying a change in the video decoder allocation between applications is required;
instructing the application assigned to the video decoder prior to receiving the event to release the video decoder, wherein the associated input buffer is placed in a suspended state until the video decoder is re-associated with the respective application; and
associating an input buffer associated with the application of the event to the video decoder to decode the respective input data stream to the decoded output data stream.

13. The mobile device of claim 12, wherein the event is determined by one of the first or second applications being in the foreground position in a user interface on the display, while the remaining application is active in a background position but not visible in the user interface on the display.

14. The mobile device of claim 12, wherein the event is derived from a user action in the user interface to initiate or resume playback of the encoded input data stream of the respective application.

15. The mobile device of claim 12 further comprising a parser associated with each of the input buffers, wherein the input buffers are parsed by the respective parser to determine the first occurrence of an intra-frame to resume processing of the respective input data stream by the video decoder when the video decoder is associated with the respective input buffer by the system controller.

16. The mobile device of claim 15 wherein the input buffer is parsed to determine the first occurrence of an intra-frame and then determining intermediate frames associated with a time index within the respective encoded input data stream, the time index identifying where the processing of the input buffer that was previously suspended.

17. The mobile device of claim 12 wherein the decoded output data stream from the video decoder is provided to an output data buffer, wherein the output data buffer is released from memory when the event is detected and re-initialized when the video decoder is assigned to a subsequent encoded input data stream.

18. The mobile device of claim 12 further comprising a touch-sensitive display for displaying the applications on the user interface.

19. The mobile device of claim 12 wherein the event is provided from an input on the touch-sensitive display defined by movement of one of the applications to a foreground position on the display having an associated encoded input data stream.

20. A computer readable memory containing instruction which when executed by a processor perform a method of video decoding resource sharing, the method comprising:
associating a video decoder with a first input buffer for a first encoded input data stream from a first application, the video decoder processing the first encoded input data stream to generate a decoded output data stream for display;
detecting an event associated with a second application that identifies a change in the video decoder allocation between the first encoded input data stream from the first application to a second encoded input data stream from the second application is required;
instructing the first application to release the video decoder; and
associating the video decoder with a second input buffer for the second encoded input data stream from the second application to provide the decoded output data stream for display, when the first application releases the video decoder wherein the first input buffer is maintained in a suspended state while the second encoded input data stream is processed by the video decoder.
